(19) United States
(12) Patent Application Publication
(10) Pub. No.: US 2010/0205218 A1
(43) Pub. Date: Aug. 12, 2010

(54) NAVIGATION DEVICE

(76) Inventors: Uwe Walkling, Barfelde (DE); Marco Fiedler, Diekholzen (DE); Henry Brandes, Woelpinghausen (DE); Holger Listle, Hildesheim (DE); Ralf Osmers, Hildesheim (DE); Thomas Klein, Alfeld (DE); Joerg Krewer, Pattensen (DE); Stefan Lueer, Hildesheim (DE)

Correspondence Address: KENYON & KENYON LLP, ONE BROADWAY, NEW YORK, NY, 10004, US

(21) Appl. No.: 12/305,804

(22) PCT Filed: Oct. 11, 2007
(86) PCT No.: PCT/EP2007/060829

§ 371 Date: Apr. 14, 2010

(30) Foreign Application Priority Data
Dec. 5, 2006 (DE) 10 2006 057 286.6

(51) Int. Cl. G06F 17/30

(52) U.S. Cl. 707/797; 707/E17.012

(57) ABSTRACT

A navigation device for a vehicle, in particular for a motor vehicle, has a hierarchical database containing a data tree with hierarchically arranged data and at least one geographic database containing data that are arranged in geographic subregions. A reference to at least one geographic database is provided in the hierarchical database.

### BACKGROUND INFORMATION

Navigation devices for vehicles, in particular for motor vehicles, and methods for operating such navigation devices are already known. They are used to determine the current geographic position of a vehicle, to calculate the respectively most favorable route as a function of a predefinable destination to be reached, and to accordingly guide the driver via optical and acoustic instructions.

The known navigation devices require information that is necessary for determining the current location of the vehicle and for calculating the route. In particular, this includes road routings, conditions for turning, defined travel directions, and the like. This information is provided in a database, which includes, for example, a so-called digital road map, which contains waypoints and/or decision points of the possible routes. Normally, the data of the database are provided on mass storage units, in particular on a CD-ROM or on a DVD in the navigation device.

A position finding system is required to determine the geographic position of the vehicle. Normally, a satellite-supported Global Positioning System (GPS) is used for this purpose.

Using these components, a device for the electronic processing of data may match the position data supplied by the position finding system with the data stored in the digital road map, and ascertain the current position of the vehicle from this. The device for electronic data processing may now give the driver route guidance information visually and/or acoustically with the aid of waypoints and/or decision points on a selected favorable route, in accordance with a selected destination.

To input the desired destination into the navigation device, the target address, having its components location, street, house number, is input letter-by-letter by scrolling within the alphabet and by confirming the selected letter with the help of buttons provided specifically for this purpose, as is known from published German patent document DE 100 12 441, for example. For each of the letters input or each sequence of letters input, a list of destination names is generated, from which the user, after sufficient input, may select the desired component, such as the city, the street, the house number, or the like.

Navigation devices typically used at present often have data that are provided in different databases. On the one hand, so-called geographic data are stored, which are filed in geographic subregions. The geographic data are normally used for queries about the surroundings and are used to this end in an alphabetically sorted manner or according to distances. On the other hand, so-called hierarchical data, which are used for hierarchical queries, are stored in another database. The hierarchical data includes hierarchies such as country, city, street, zip code, or house number. Both databases are separated and thus information content exists redundantly in the navigation device.

### SUMMARY

An objective of the present invention is thus to provide a navigation device and a method for defining a destination or point of interest in a navigation device, by which the required data volume is reduced.

The present invention provides a navigation device that is suitable in particular for land vehicles such as motor vehicles. For destination input or point input, the navigation device has a hierarchical database that is used for hierarchical queries. The hierarchical database has a data tree having hierarchically arranged data. Furthermore, at least one geographic database is provided in the navigation device, which has data that are arranged in geographic subregions. At least one reference that refers to at least one geographic database is provided in the hierarchical database.

Through the linking of the data via references in the tree structure, it is no longer necessary for all paths to be completely held in the hierarchical database. Thus, the data volume held may be reduced without any loss of information.

In a preferred specific embodiment of the present invention, the hierarchical database has country, city, and street hierarchies, and the reference is provided hierarchically under the country hierarchy. In this embodiment, the reference may be provided, for example, in place of the hierarchy point city or street.

Furthermore, in the data structure of the hierarchical database, the reference may be provided in addition to the hierarchy points of the hierarchical database.

Likewise, a plurality of references to at least one geographic database may be provided.

To define a destination or a point of interest in a navigation device that includes a hierarchical database with a data tree having hierarchically arranged data and at least one geographic database having data that are arranged in geographic subregions, a specific hierarchy level of the hierarchical database is then linked to a geographic database, in particular by a reference.

When the method is implemented, the linking may be made a function of the data volume to be processed, and/or how high the number of geographic regions to be considered is.

Now it is in particular advantageous that the data paths in the hierarchical database only have to be maintained to the extent that it is necessary due to the external boundary conditions such as, for example, the necessary system performance or the memory requirement. Thus, the data volume for unnecessary paths in the tree is reduced without information being lost. Additional processing then takes place on the basis of the data that exists in the geographic subregions.

Additional advantages and advantageous specific embodiments of the present invention will now be described with reference to the figures and their relevant descriptions.

### BRIEF DESCRIPTION OF THE DRAWINGS

FIG. 1 schematically shows a block diagram of a navigation device having a hierarchical and a geographic database according to a specific embodiment of the present invention.

FIG. 2 schematically shows a link between the hierarchical and the geographic database of FIG. 1.

FIG. 3 schematically shows a method for defining a destination in a navigation device according to a specific embodiment of the present invention

FIG. 4 schematically shows a link between an additional hierarchical database and the geographic database according to a specific embodiment of the present invention.

### DETAILED DESCRIPTION OF EXAMPLE EMBODIMENTS

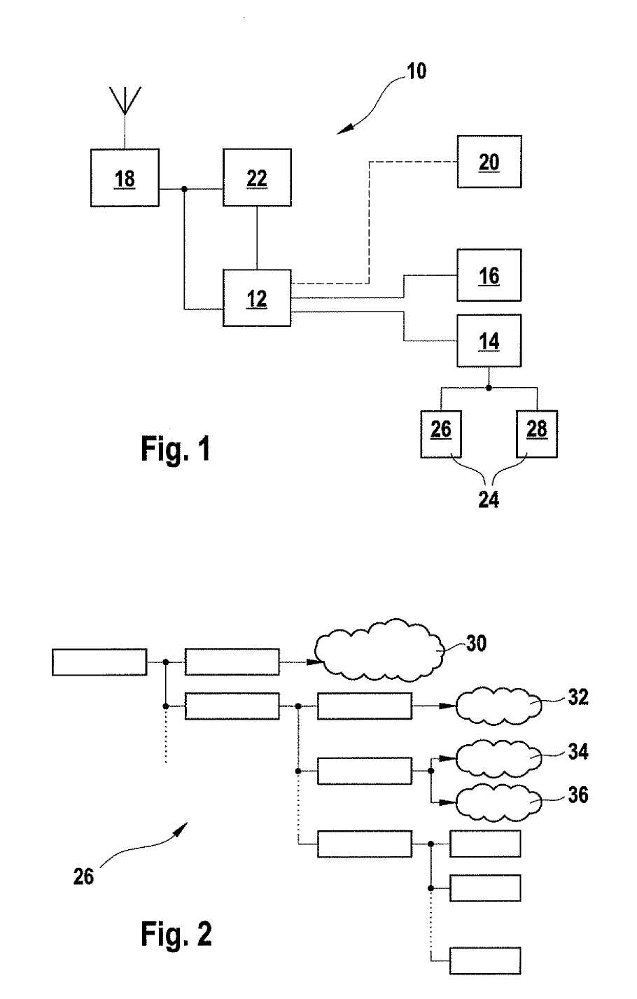

FIG. 1 illustrates schematically a block diagram of a navigation device 10, which has a route calculator 12 for route guidance, in particular for guiding a driver of a land vehicle along a route. On its input side, route calculator 12 is connected to a destination input unit 14, a road map memory 16, and a position detecting module 18 such as a GPS module. Optionally, a connection between route calculator 12 and a traffic information system 20 may also be provided. Route calculator 12 may thus calculate the quickest or shortest route on the basis of a destination position input with the aid of destination input device 14 and a current starting position transmitted by position detecting module 18. The calculated route is then transmitted to a guidance unit 22 connected to route calculator 12. The guidance unit then gives the user optical and/or acoustic guidance instructions, it being possible to also consider current traffic data provided by traffic information system 20.

Destination input unit 14 is connected to destination databases 24, in which information regarding possible destinations is stored. In this context, destination databases 24 are implemented as at least one hierarchical database 26 and at least one geographic database 28. In geographic database 28, destination data are stored in geographic subregions. The destination data are used predominantly for queries regarding the surroundings and are sorted alphabetically or sorted according to distances. In hierarchical database 26, destination data are stored hierarchically, e.g., in country, city, street, and house number hierarchies. In this context, references to the geographic database are stored in hierarchical database 26, which will be described in further detail in conjunction with FIG. 2.

FIG. 2 illustrates schematically and by way of example possible links between the hierarchical and the geographic database. In the example shown in FIG. 2, the hierarchical database 26 is subdivided into country, city, street, and house number hierarchies (shown as boxed columns, from left to right). A city and B city through Z city are specified as general examples. References 30 to the corresponding regions in geographic database 28 may in principle be provided at any hierarchy level of the hierarchical database. As an example, in FIG. 2, a reference 30 to geographic database 28 is input already after the hierarchy A city. This reference is used to extract accordingly the subordinated data from geographic database 28.

Reference 32 and references 34 and 36 are indicated as additional examples in the hierarchical database 26 of FIG. 2, and respectively reference the corresponding data of geographic database 28 after the street hierarchy, e.g., after A street and B street, respectively, as shown in FIG. 2. In this context, a plurality of references, e.g., the references 34 and 36, may also be provided per hierarchy, as shown in the example of B city.

One decision criterion for the position at which a path in hierarchical database 26 is cut off and replaced by a reference to geographic database 28 may lie in how large the number of geographic regions to be considered in the respective hierarchy is, for example. The data volume to be considered in each instance may also be used as an additional decision criterion.

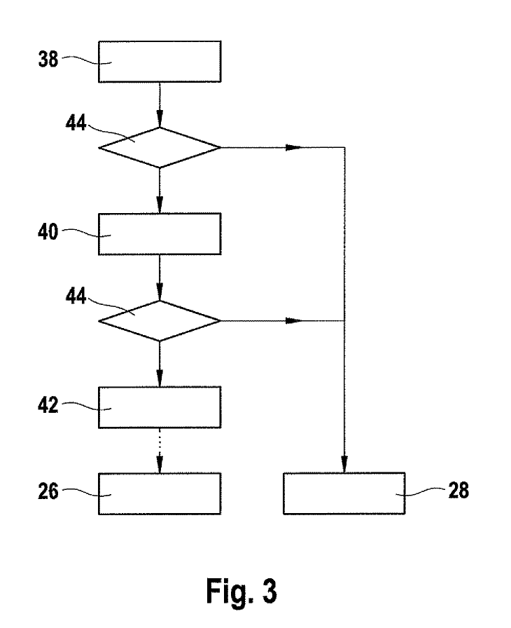

A method for defining a destination or a point of interest in a navigation device 10 according to a specific embodiment of the present invention is implemented with a hierarchical database 26 having a data tree with hierarchically arranged data and a geographic database 28 having data that are arranged in geographic subregions. The method is illustrated schematically in FIG. 3. To define the destination, a first hierarchy of the destination, e.g., the country, is defined first in first hierarchy step 38. In subsequent decision step 44, a check is carried out to see whether after this hierarchy step a reference to a geographic database 28 exists for the concretely selected hierarchy, e.g., for the selected country. If this is the case, the data still missing are obtained from geographic database 28. If this is not the case, next hierarchy step 40 is processed in hierarchical database 26. In this instance, a city may be selected, for example. Afterwards, in decision step 44, a check is carried out again to see whether a reference to geographic database 28 exists for the concretely selected hierarchy, that is, the concrete city. If this is now the case, the data still missing are obtained from geographic database 28. If this is not the case, next hierarchy step 42 is processed again in hierarchical database 26. This procedure is now repeated until either a reference is found or all information for the destination is taken from hierarchical database 26 for the concretely selected destination.

The structure and the specific development of the geographic regions in the geographic database is generally arbitrary. However, the data that do not exist in hierarchical database 26 must be able to be taken from geographic database 28 via the reference.

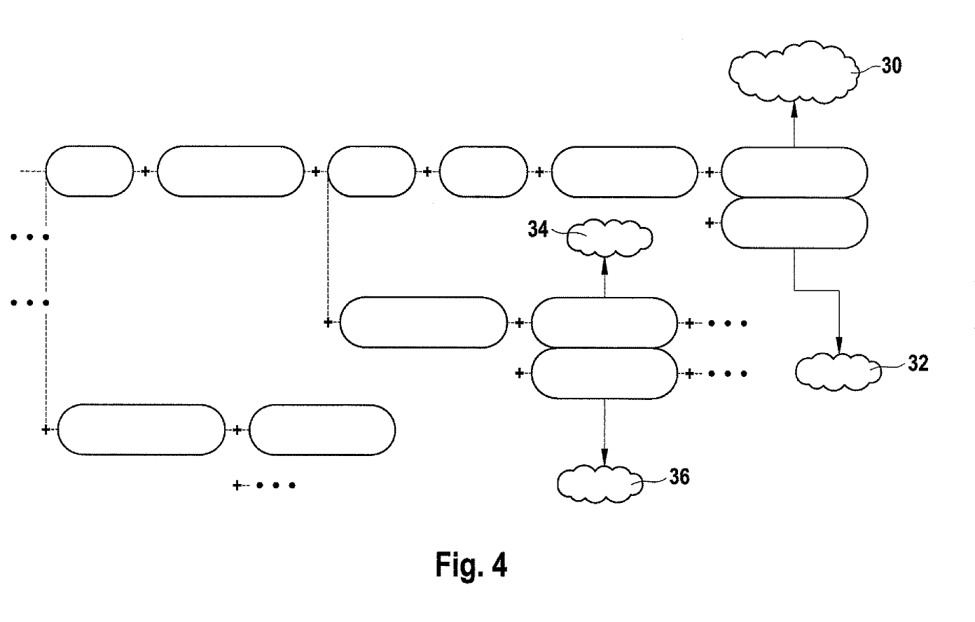

FIG. 4 illustrates schematically and by way of example a possible link between an additional hierarchical database and the geographic database 28. In the example shown in FIG. 4, additional hierarchical database 26 is subdivided into the hierarchies of country, city, and special destinations. As an illustrative example, Germany is the country, city A is the city, and restaurant and parking lot are special destinations. The special destinations may represent any type of point of interest. A reference 30 from the special destination restaurant to geographic database 28 may be input. From the special destination parking lot, an additional reference 32 may refer to corresponding data of geographic database 28.

Furthermore, the additional database after the country hierarchy may have supraregional destinations such as border crossing or airport. References 34 and 36 respectively reference from the border crossing and the airport to corresponding data of geographic database 28, and may be stored. Furthermore, global points may be stored in the hierarchy, which are again subdivided into telephone numbers, for example. The global points represent points of interest.

1-8. (canceled)

9. A navigation device for a land vehicle, comprising:
a hierarchical database containing a data tree with hierarchically arranged data; and
at least one geographic database containing data that are arranged in geographic subregions, wherein the hierarchical database includes a reference to the at least one geographic database.

10. The navigation device as recited in claim 9, wherein the hierarchical database is structured hierarchically at least according to country, city, and street, and the reference is provided hierarchically below the country hierarchy.

11. The navigation device as recited in claim 10, wherein the reference is provided in place of a hierarchy point corresponding to one of the city hierarchy and the street hierarchy.

12. The navigation device as recited in claim 9, wherein the reference is provided in addition to hierarchy points of the hierarchical database.

13. The navigation device as recited in claim 9, wherein a data structure of the hierarchical database includes a plurality of references to the at least one geographic database.

14. A method for defining one of a destination and a point of interest in a navigation device including a hierarchical database containing a data tree with hierarchically arranged data and at least one geographic database containing data that are arranged in geographic subregions, comprising:
linking data from the hierarchical database to data from the geographic database, resulting in a definition of the destination/point of interest.

15. The method as recited in claim 14, further comprising:
linking the data from the hierarchical database to the data from the geographic database via a reference in the hierarchical database.

16. The method as recited in claim 14, further comprising:
linking the data from the hierarchical database to the data from the geographic database in view of at least one of regions to be considered and data volume to be processed.
